(19) United States
(12) Patent Application Publication
(10) Pub. No.: US 2006/0116279 A1
(43) Pub. Date: Jun. 1, 2006

(54) Composite particles and method for production thereof and use thereof

(76) Inventors: Hisao Kogoi, Toyama (JP); Masayuki Sanbayashi, Toyama (JP); Jun Tanaka, Chiba (JP)

Correspondence Address: SUGHRUE MION, PLLC, 2100 PENNSYLVANIA AVENUE, N.W., SUITE 800, WASHINGTON, DC, 20037, US

(21) Appl. No.: 10/542,023

(22) PCT Filed: Jan. 9, 2004
(86) PCT No.: PCT/JP04/00101

§ 371 Date: Jul. 11, 2005

(30) Foreign Application Priority Data
Jan. 9, 2003 (JP) 2003-3307
Jan. 17, 2003 (US) 60440630

(51) Int. Cl. C08F 4/02; C09B 67/50

(52) U.S. Cl. 502/103; 106/412

(57) ABSTRACT

A composite particle comprised of a larger particle and, supported thereon, smaller particles wherein the smaller particles are photocatalyst-containing fine particles with an average particle diameter of 0.005-0.5 μm as calculated from a BET specific surface area, and the larger particle has an average particle diameter of 2-200 μm as measured by the laser diffraction-scattering particle size measuring method. The smaller particle is preferably a composite particle of titanium dioxide with an inorganic compound exhibiting no catalytic activity, such as silica, or a particle containing a Brφonsted acid salt, especially on the surface thereof; and an advantageous method for producing the above composite particles wherein the above larger particles and smaller particles are dry mixed by a ball-mill or mixed by rotation of blades or by shaking, with an energy constant controlled within a specific range. A composition comprising an organic polymer and the above composite particles can give a shaped article, such as fiber, film or a molding, exhibiting ultraviolet ray-screening function.

### TECHNICAL FIELD

This invention relates to a composite particle, a method for the production thereof, and use thereof.

The composite particle of the present invention comprises a larger particle and, supported thereon, fine particles having a photo-catalytic activity. The composite particle exhibits highly effectively a photo-catalytic activity, and is useful as a structure, a shaped article, a film or a fiber which exhibit a photo-catalytic activity.

### BACKGROUND ART

Many kinds of inorganic fine particles are known as having a photo-catalytic activity. A most typical example of the inorganic fine particles is titanium dioxide fine particles.

Titanium dioxide absorbs ultraviolet rays, and consequently, positive holes and electrons are generated inside the fine particles. The positive holes react with water adsorbed in the titanium dioxide, and generate hydroxyl radicals, which has a function of decomposing organic matter, adsorbed on the surface of titanium dioxide particles, into carbon dioxide gas and water (see Akira Fujishima, Kazuhito Hashimoto and Toshiya Watanabe, Light Cleaning Revolution, published by C.M.C. 1997). This function is referred to as photo-catalytic function. Titanium dioxide exhibits a strong photo-catalytic activity provided that positive holes are easily generated and positive holes easily migrate to the surface of titanium dioxide particles (see The Whole of Titanium Dioxide Photocatalyst, edited by Kazuhito Hashimoto and Akira Fujishima, published by C.M.C. 1997). As titanium dioxide exhibiting a strong photo-catalytic activity, there can be mentioned anatase-type titanium dioxide particles, titanium dioxide particles having reduced lattice defects, and titanium dioxide particles having a small particle diameter and a large specific surface area.

Most of organic matter can be decomposed by the above-mentioned photo-catalytic function, and therefore, beneficial functions such as anti-fungus, self-cleaning, deodorizing and anti-staining functions can be imparted, for example, to tiles, building materials, constructional materials, fibers, films and other materials by allowing these materials to support titanium dioxide particles on the surfaces thereof.

The above-mentioned photo-catalytic function is manifested on the surfaces of titanium dioxide particles, and therefore, titanium dioxide particles must be located on the surfaces of the materials or members to which the beneficial functions are to be imparted. A simple and easy method for this requirement includes a method of coating the material or member with a composition comprising titanium dioxide and a binder. However, in the case when an organic high polymer is used as the binder, the binder is easily oxidized and/or decomposed by the photo-catalytic function. Therefore, a binder, which is not subject to decomposition, such as a fluororesin or a silicone resin, must be used (see Japanese Patents No. 2756474 and 3027739).

However, in the case when photo-catalytic semiconductor particles are used as a mixture thereof with a resin binder, the resin binder is liable to cover the surfaces of titanium dioxide particles and thus, the exposure of the photo-catalytic titanium dioxide-particles to light, and the contact of the titanium dioxide particles with the material or member to which the beneficial properties are to be imparted, are impeded. Consequently a problem arises in that the photo-catalytic effect of titanium dioxide is reduced. Further another problem arises in that the resin binder must be cured by heating.

As for a composite particle comprising titanium dioxide particles, composite particles have been proposed for various purposes. Most composite particles comprise a combination of a particle having a larger diameter (hereinafter referred to as “Mother particle” when appropriate) with particles having a smaller diameter (hereinafter referred to as “child particle” when appropriate). The mother particle has a function of manifesting the performance of child particles with an enhanced efficiency. In the case when there is no great difference in size between two kinds of particles, fine particles having a desired performance are referred to as “child particles”, and particles having a function of manifesting the desired performance of child particles with enhanced efficiency is referred to as “mother particles”.

For composite particles comprising titanium dioxide particles, most of the composite particles comprise titanium dioxide particles as the child particles because titanium oxide particles exhibit various performances such as opacifying effect, photo-catalytic effect and ultraviolet rays-screening effect. Mother particles used for the titanium dioxide-containing composite particles are chosen so that the maximum effect of titanium dioxide is manifested. As examples of the mother particles for giving titanium dioxide-containing composite particles, there can be mentioned mother particles having a specific refractive index difference and a specific band gap in order to obtain the maximum ultraviolet rays-screening effect of ultra-fine titanium dioxide particles (Japanese Unexamined Patent Publication [hereinafter abbreviated to as “JP-A”] No. H11-131408, JP-A H9-100112 and JP-A H8-268707: silica mother particles in order to impart high transparency for the same purpose (JP-A 2000-344509); and calcium carbonate mother particles for obtaining an enhanced opacifying effect of titanium dioxide particles (JP-A 2002-29739). Further there have been proposed finely divided inorganic particles having titanium dioxide supported on the surfaces thereof by using an organic binder in order to enhance the photo-catalytic activity of titanium dioxide (Japanese Patent 3279755); and aluminosilicate particles as the mother particles in order to provide a composite particle exhibiting a photo-catalytic activity without deterioration of a resin even when the composite particle is placed in contact with the resin(JP-A H11-76835). Further there have been proposed a method of mechanically combining mother particles with child particles by a high-speed airflow impacting method (Japanese Examined Patent Publication No. H3-2009 and JP-A H6-210152); and a method of combining mother particle with child particles by a surface melting method (Japanese Patent No. 2672671).

Titanium dioxide has a catalytic activity and therefore its utilization is restricted. That is, when an organic high polymer is used as a binder, the polymer is oxidized and decomposed by the action of titanium dioxide. Even if a binder which is not easily decomposed, such as a fluororesin or a silicone resin, is used, the binder covers the surfaces of titanium dioxide particles and inhibits the exposure of titanium dioxide to light and the contact of material to be decomposed with titanium dioxide, thus reducing the photo-catalytic effect. Further the resin binder must be cured by heating. Even If titanium dioxide Is used as a composite particle to enhance the desired function of titanium dioxide, the above-mentioned problems arise.

### DISCLOSURE OF THE INVENTION

Objects of the present invention are to provide a photo-catalytic composite particle comprising titanium dioxide particles or other photo-catalytic inorganic oxide particles which exhibits enhanced photo-catalytic activity with high efficiency and practical use of which is not restricted; a method for producing the composite particle; an organic polymer composition comprising the composite particle; and applications of the composite particle.

The inventors made intensive researches, and found that the above-mentioned problems of the prior art can be overcome by a composite particle comprised of a larger particle and smaller particles which are photocatalyst-containing fine particles having a specific average particle diameter as calculated from a BET surface area, especially titanium dioxide-silica fine composite particles or fine particles containing a Brφnsted acid salt, especially titanium dioxide fine particles containing a Brφnsted acid salt on the surface thereof. The present invention has been completed based on this finding.

Thus, in accordance with the present invention, there are provided the following composite particle, method for producing the composite particle, organic polymer composition, and applications of the composite particle.

(1) A composite particle comprised of a larger particle and, supported thereon, smaller particles wherein the smaller particles are photocatalyst-containing fine particles having an average particle diameter in the range of 0.005 μm to 0.5 μm as calculated from a BET specific surface area, and the larger particle has an average particle diameter in the range of 2 μm to 200 μm as measured by the laser diffraction-scattering particle size measuring method.

Typical embodiments of the composite particle as mentioned above in (1) include those which are recited below in (2) through (12).

(2) The composite particle as mentioned above in (1), wherein the smaller particles comprise titanium dioxide as a photocatalyst.

(3) The composite particle as mentioned above in (1), wherein the smaller particles are composite particles comprising titanium dioxide and an inorganic compound exhibiting no photo-catalytic activity.

(4) The composite particle as mentioned above in (1), wherein the inorganic compound exhibiting no photo-catalytic activity is silica and the content of silica in the smaller particles is at least 0.5% by mass but not larger than 50% by mass, based on the mass of the smaller particles.

(5) The composite particle as mentioned above in-any one of (1) to (4), wherein the smaller particles contain a Brφnsted acid salt.

(6) The composite particle as mentioned above in (5), wherein the smaller particles are titanium dioxide particles containing the Brφnsted acid salt on the surfaces of particles.

(7) The composite particle as mentined above in (6), wherein the Brφnsted acid salt is a condensed phosphate.

(8) The composite particle as mentioned above in any one of (5) to (7), wherein the smaller particles contain the Brφnsted acid salt in an amount In the range of 0.01% by mass to 50% by mass.

(9) The composite particle as mentioned above in any one of (2) to (8), wherein the titanium dioxide comprises a brookite crystalline phase.

(10) The composite particle as mentioned above in (1) to (9), wherein the larger particle is a spherical resin particle having a melting point of at least 150° C.

(11) The composite particle as mentioned above in any one of (1) to (9), wherein the larger particle is comprised of a hydroxide, oxide or carbonate, which contains at least one kind of element selected from the group consisting of aluminum, magnesium, calcium and silicon.

(12) The composite particle as mentioned above in any one of (1) to (11), wherein the amount of smaller particles is in the range of 0.5% by mass to 40% by mass based on the mass of the larger particle.

(13) A method of producing a composite particle as mentioned above in any one of (1) to (12), comprising dry-mixing the smaller particles and the larger particle by a ball mill, characterized in that the dry-mixing is carried out under conditions such that k value as defined by the following equation (1) is in the range of 50 to 50,000,
k=(wm/wp)×d×n×t equation (1):
where k is energy constant for dry-mixing,

wp is total mass (g) of particles to be dry-mixed,

wm us mass (g) of mixing media,

d is inner diameter (m) of ball mill,

n is number of rotation (rpm) of ball mill, and

t is time (min) for dry-mixing.

(14). A method of producing a composite particle as mentioned above in any one of (1) to (12), comprising mixing, pulverizing and stirring the smaller particles and the larger particle by a powder-treating apparatus provided with rotary blades, characterized in that the mixing, pulverizing and stirring are carried out under conditions such that k2 value as defined by the following equation (2) is in the range of 250 to 50,000,
k2=n×t equation (2):
where n is number of rotation (rpm) of rotary blades, and

t is time (min) for mixing, pulverizing and stirring.

(15) A method of producing a composite particle as mentioned above in any one of (1) to (12), comprising mixing, pulverizing and stirring the smaller particles and the larger particle by a shaking-type powder-treating apparatus, characterized in that the mixing, pulverizing and stirring are carried out under conditions such that k3 value as defined by the following equation (3) is in the range of 50 to 50,000,
k3=n×t equation (3):
where n is number of shaking per minute, and

t is time (min) for mixing, pulverizing and stirring.

(16) A organic polymer composition comprising an organic polymer and a composite particle as claimed in any one of claims 1 to 12, wherein the amount of the composite particle is in the range of 0.01% to 80% by mass based on the total mass of the organic polymer composition.

Typical embodiments of the organic polymer composition as mentioned above in (16) include those which are recited below in (17) through (19).

(17) The organic polymer composition as mentioned above in (16) wherein the organic polymer is at least one kind of resin selected from the group consisting of synthetic thermoplastic resins, synthetic thermosetting resins and natural resins.

(18) The organic polymer composition as mentioned above in (16) or (17) wherein the organic polymer composition is a compound.

(19) The organic polymer composition as mentioned above in (16) or (17) wherein the organic polymer composition is a master batch

(20) A shaped article made by shaping an organic polymer composition as mentioned above in any one of (16) to (19).

Typical applications of the composite particle as mentioned above in any one of (1) through (12) include those which are recited below in (21) through (26).

(21) A coating composition comprising a composite particle as mentioned above in any one of (1) to (12).

(22) A paint composition comprising a composite particle as mentioned above in any one of (1) to (12).

(23) A structure comprising on a surface thereof a composite particle as mentioned above in any one of (1) to (12).

(24) A cosmetic composition comprising a composite particle as mentioned above in any one of (1) to (12).

(25) A fiber comprising a composite particle as mentioned above in any one of (1) to (12).

(26) A film comprising a composite particle as mentioned above in any one of (1) to (12).

### BEST MODE FOR CARRYING OUT THE INVENTION

The composite particle of the present invention is characterized as being comprised of a larger particle and, supported thereon, smaller particles wherein the smaller particles are photocatalyst-containing fine particles having an average particle diameter in the range of 0.005 μm to 0.5 μm as calculated from a BET specific surface area, and the larger particle has an average particle diameter In the range of 2 μm to 200 μm as measured by the laser diffraction-scattering particle size measuring method.

The photocatalyst-containing fine particles are excited by ultraviolet rays and visible light to give conduction electrons and positive holes. As specific examples of the photocatalyst-containing fine particles, there can be mentioned fine particles of titanium dioxide, tin oxide, zinc oxide, ferric oxide, tungsten trioxide, dibismuth trioxide and strontium titanate. Of these, titanium dioxide is preferable because of chemical stability.

Especially preferable smaller particles are composite particles comprising titanium dioxide and an inorganic compound exhibiting no photo-catalytic activity. As specific examples of the inorganic compound exhibiting no photo-catalytic activity, there can be mentioned inorganic compounds containing Mg, Si, Ca, Fe or Zr. Of the inorganic compounds, silica Is preferable.

The reason for which composite particles comprising titanium dioxide and an inorganic compound exhibiting no photo-catalytic activity, especially titanium-silica composite particles, are preferable as child particles are as follows. Titanium dioxide ingredient in the composite particles has photo-catalytic activity, and Mg, Si, Ca, Fe or Zr ingredient exhibits a strong binding performance via an oxygen atom for binding a mother particle with child particles or binding child particle with a resin. Further, the inorganic compound exhibiting no photo-catalytic activity does not decompose an organic polymer binder adjacent to the inorganic compound, and thus, the composite particles exhibit good weather resistance. If the particular kinds of mother particle and child particles are selected so that they are strongly bonded together, especially excellent composite particles are obtained. Thus, composite particles comprising titanium dioxide and an inorganic compound exhibiting no photo-catalytic activity, especially titanium-silica composite particles, as child particles, give a composite particle exhibiting high photo-catalytic activity, and give a structure having high durability, even when a conventional organic polymer binder is used.

Smaller particles containing a Brφnsted acid salt are also preferable. Titanium dioxide particles containing a Brφnsted acid salt on the surfaces of particles are especially preferable because the Brφnsted acid salt on the particle surface has a function for strongly binding a mother particle with child particles. In the case when titanium dioxide particles containing a Brφnsted acid salt on the surfaces of particles are used, a photo-catalytic activity can be manifested-even to a weak light such as a ultraviolet rays of an intensity of, e.g., about 6 μW/cm². By using as child particles titanium dioxide-silica composite particles and/or titanium dioxide fine particles containing a Brφnsted acid salt, a composite particle exhibiting high photo-catalytic activity and a structure having high durability are obtained, even when a conventional organic polymer binder is used.

The state of the Brφnsted acid salt on the surfaces of smaller particles is not particularly limited, but preferably the Brφnsted acid salt conceals partly the surfaces of smaller particles and the covering of Brφnsted acid salt may be of any fashion including, for example, islands form and mask-melon form (i.e., network form).

When the titanium dioxide-silica composite fine particles or the Brφnsted acid salt-containing fine titanium dioxide particles are combined as child particles with a mother particle having an adequate particle size, a preferable composite particle is obtained. In the case when this composite particle is incorporated in a resin to form a fiber or a film or the composite particle is incorporated with a binder to form a coating on a surface of a base material, or the composite particle is incorporated in a structural member, the mother particle of the composite particle is capable of being partly exposed to light, that is, titanium dioxide present on the surface of mother particle can be partly exposed to light. Further, when an organic polymer is used as a binder, the surface of mother particle having no photo-catalytic activity is partly directly contacted and connected with the binder, and therefore, even when the organic polymer binder partly contacted with titanium dioxide is oxidized or decomposed, the connection between the organic polymer binder and the composite particle can be retained, and the undesirable separation of the titanium dioxide-silica composite fine particles or the Brφnsted acid salt-containing fine titanium dioxide particles from the mother particle can prevented or minimized. Therefore, the above-mentioned composite particle of the present invention can give a durable structure exhibiting a photo-catalytic activity for a long period of time. Such durable structure can be obtained without use of an expensive fluororesin or silicone resin which is not easily decomposed.

The amount of smaller particles in the composite particle of the present invention is preferably in the range of 0.5% by mass to 40% by mass based on the mass of the larger particle. When the amount of smaller particles is too small, a photo-catalytic activity of desired extent cannot be obtained. In contrast, when the amount of smaller particles is too large, the proportion of mother particle exposed on the surface of a structure becomes too small, and thus the exposure of titanium dioxide present on the surface of mother particle is liable to be insufficient.

A preferable titanium dioxide-silica composite fine particle of the present invention is composite metal oxide particles (mixed crystal particles) wherein titanium dioxide and silicon oxide exist in a mixed crystal state as primary particle. The composite metal oxide ultrafine mixed crystal particles wherein titanium dioxide and silicon oxide exist in a mixed crystal state as primary particles are prepared by a gaseous phase method or a liquid phase method. The preparation method is not particularly limited. A preferable example of the preparation method is described, for example, in WO01/56930. More specifically the composite metal oxide ultrafine mixed crystal particles are prepared by a process wherein a mixed gas comprised of at least one compound selected from titanium chloride, titanium bromide and titanium iodide and at least one compound selected from silicon chloride, silicon bromide and silicon iodide, and an oxidizing gas are separately pre-heated at a temperature of at least 500° C., and then the pre-heated gases are allowed to react with each other.

In the case when a composite particle of the present invention is used for purposes other than the utilization of the photo-catalytic activity of titanium dioxide, a different metal oxide crystalline structure having a core/shell structure may be adopted. For example, there can be adopted a titanium dioxide-silica composite particle comprised of primary particles containing a mixed crystal state having a titanium-oxygen-silicon bond, which have a core predominantly comprised of TiO₂ phase and a sheath predominantly comprised of SiO₂ phase. The SiO₂ phase may be present In the sheath either in the form of a dense layer, or a islands, a group of islands or a network.

Preferable child particles in the composite particle of the present invention are not a simple mixture comprised of a titanium dioxide powder and a silica powder, regardless of uses. Titanium dioxide in the titanium dioxide-silica composite fine particle wherein titanium dioxide and silicon oxide exist in a mixed crystal state as primary particles, may be any of anatase, rutile and brookite crystalline phases. From a viewpoint of high photo-catalytic activity, anatase titanium dioxide and brookite titanium dioxide are preferable. From a viewpoint of ultraviolet rays-screening, rutile titanium dioxide and anatase titanium dioxide are preferable.

The smaller particles, i.e., child particles used in the present invention, have an average primary particle diameter in the range of 0.005 μm to 0.5 μm (i.e., 5 nm to 500 nm), preferably 0.02 μm to 0.2 μm and more preferably 0.05 μm to 0.15 μm as calculated from a BET specific surface area. The particle diameter as calculated from a BET specific surface area is determined by converting the particles as sphere particles and calculating the particle diameter according to the following equation:
D1=6/ρS
where D1 is particle diameter as calculated from a BET specific surface area, ρ is density of particle, and S is specific surface area of particle

As the particle diameter of particles having a photo-catalytic activity decreases, that is, the specific surface area of the particles increases, the photo-catalytic activity is enhanced. Therefore, the average primary particle diameter is up to 0.5 μm. If the average primary particle diameter is larger than 0.5 μm (500 nm), the photo-catalytic activity is generally low. However, if the average primary particle diameter is smaller than 5 nm, a powder comprising the child particles is bulky and difficult to handle and the productivity is liable to be drastically reduced.

The content of silica in the child particles is in the range of 0.5% by mass to 50% % by mass, preferably 1% by mass to 30% by mass, and more preferably 1.5% by mass to 25% by mass. If the silica content is smaller than 0.5% by mass, an organic structure containing the child particles tends to be subject to yellow change and its tenacity is liable to be lowered, when it is irradiated with light. This would be due to the fact that probability of contact between titanium dioxide and an organic material increases. In contrast, if the silica content in the child particles is larger than 50% by mass, the photo-catalytic activity of titanium dioxide tends to be manifested to a reduced extent. This would be due to the fact that the relative amount of titanium dioxide is reduced.

Now child particles containing a Brφnsted acid salt will be described.

The Brφnsted acid salt used is not particularly limited, and, as specific examples thereof, there can be mentioned phosphates, condensed phosphates, borates, sulfates, condensed sulfates and carboxylates. Of these, preferable are salts capable of forming a compound insoluble in water or only slightly soluble in water together with the metal constituting the mother particle. Of these, polybasic acid salts such as condensed phosphates, borates, condensed sulfates and polycarboxylates are preferable. Condensed phosphates are especially preferable.

The condensed phosphates include, for example, pyrophosphates, tripolyphosphates, tetrapolyphosphates, metaphosphates and ultraphosphates. Of these, pyrophosphates and tripolyphosphates are preferable.

The Brφnsted acid salt may be present either alone or as a combination of two or more thereof.

The content of Brφnsted acid salt in the smaller particles is preferably in the range of 0.01% by mass to 50% by mass, If the content of Brφnsted acid salt is too small, a photo-catalytic activity of a desired extent cannot be manifested upon irradiation with weak light, and the durability of a photo-catalytic structure is liable to be reduced. In contrast, if the content of Brφnsted acid salt is too large, the relative area of titanium dioxide or other material having a photo-catalytic activity, exposed on the surfaces of particles, is reduced and the photo-catalytic performance tends to be lowered.

The child particles preferably have a BET specific surf ace area in the range of 5 to 300 m²/g. The average particle diameter as calculated from this BET specific surface area is in the range of 0.005 μm to 0.3 μm. The BET specific surface area is more preferably in the range of 30 to 250 m²/g, especially preferably 50 to 200 m²/g. If the BET specific surface area is smaller than 10 m²/g, the photo-catalytic activity tends to be small. In contrast, a composite particle having child particles having a BET surface area of at least 300 m²/g is difficult to produce with good productivity and thus is of poor practicality.

Titanium oxide may have any of anatase, rutile and brookite crystalline phases. Anatase and brookite crystalline phases are preferable. Brookite crystalline phase is especially preferable. Titanium oxide may have two or more of the three crystalline phases. In some cases, the activity of titanium dioxide having at least two crystalline phases is larger than those of the sum of respective single crystalline phases.

The process for preparing the titanium dioxide is not particularly limited, but, the titanium dioxide is generally prepared by a vapor phase process using a TiCl₄ material, or a liquid phase process using an aqueous TiCl₄ solution or an aqueous titanyl sulfate solution. The liquid phase process using an aqueous TiCl₄ solution includes, for example, a process as described in JP-A H11-43327 wherein titanium tetrachloride is incorporated in hot water maintained at a temperature of 75 to 100° C. and then hydrolysis is effected at a temperature of 75° C. to the boiling point of the solution to prepare an aqueous sol of brookite titanium dioxide.

To support titanium dioxide on the surface of mother particle with an enhanced efficiency, titanium dioxide prepared by the liquid phase process is preferably used. More preferably titanium dioxide slurry as obtained in the liquid phase process is used as it is, namely, without drying into a titanium oxide powder. This is because titanium dioxide undesirably agglomerates in the step of preparing a powder from the slurry as-obtained in the liquid phase process. Thus an additional step of pulverizing the agglomerates by using an air-stream pulverizer such as a micronizer or jet mill, a roller mill or a pulperizer is needed.

The aqueous titanium dioxide slurry used preferably has a titanium dioxide content in the range of 0.1% to 10% by mass, more preferably 0.5% to 5% by mass. When the titanium dioxide content in slurry is larger than 10% by mass, titanium dioxide tends to be agglomerated in the succeeding mixing step. In contrast, when the titanium dioxide content in slurry is smaller than 0.5% by mass, the productivity is lowered.

The titanium dioxide in the aqueous slurry preferably has a pH value in the range of 3 to 5. When the pH value of titanium dioxide is lower than 3, titanium dioxide tends to be agglomerated by local neutralization or exothermic heat at mixing in the succeeding reaction step. When the titanium dioxide has a pH value higher than 5, the agglomeration undesirably proceeds. If desired, an aqueous titanium dioxide slurry as obtained by a vapor phase process or a liquid phase process may be treated by electrodialysis or with ion-exchange resin to adjust the pH value.

The method of preparing composite particles of titanium dioxide with a Brφnsted acid salt is not particularly limited, but preferably the Brφnsted acid salt is used as an aqueous solution. If the Brφnsted acid salt is incorporated as a powder in an aqueous slurry of titanium dioxide, the titanium dioxide occasionally tends to exhibit a low absorbance of visible light.

If a Brφnsted acid salt used has a poor solubility in water, aqueous solutions of a plurality of raw materials capable of forming a compound having a poor solubility in water are preferably used. For example, when composite particles of titanium dioxide with calcium pyrophosphate are prepared, it is preferable to use in combination an aqueous solution of sodium pyrophosphate and an aqueous solution of calcium chloride.

The aqueous solution of a Brφnsted acid salt preferably has a concentration of not higher than 40% by mass, more preferably not higher than 20% by mass. When the concentration of a Brφnsted acid salt is higher than 40% by mass, titanium dioxide tends to be locally agglomerated in the succeeding mixing step.

The amount of a Brφnsted acid salt used is in the range of 0.01% to 50% by mass based on the mass of the smaller particles. Usually the amount of a Brφnsted acid salt used is in the range of 0.01% to 100% by mass, preferably 0.1% to 50% by mass, based on the mass of the titanium dioxide. When the amount of a Brφnsted acid salt Is smaller than 0.01% by mass, its reactivity with titanium dioxide is insufficient. In contrast, the use of a Brφnsted acid salt in an amount of larger than 50% by mass is not advantageous from cost considerations, and occasionally leads to agglomeration of titanium dioxide particles.

For the preparation of a composite particle, an aqueous titanium dioxide slurry is mixed with the aqueous solution of a Brφnsted acid salt.

The mixing is preferably carried out at a pH value in the range of 4 to 10, more preferably 5 to 9. If the pH value is lower than 4, the reactivity of titanium dioxide with a Brφnsted acid salt is insufficient. In contrast, if the pH value is higher than 10, titanium dioxide tends to be undesirably agglomerated at mixing.

The adjustment of pH value at mixing can be carried out when an aqueous titanium dioxide slurry is mixed with the an aqueous solution of a Brφnsted acid salt, or the pH value of the aqueous Brφnsted acid salt solution can be previously adjusted so that a mixed solution thereof having a desired pH value is obtained when the aqueous Brφnsted acid salt solution is mixed with an aqueous titanium dioxide slurry. The adjustment of pH value can be effected by adding an aqueous solution of a mineral acid such as hydrochloric acid or sulfuric acid, or a base such as sodium hydroxide or ammonia. It should be noted, however, that the amount of pH adjuster is minimized as soon as possible or the pH adjuster is used at a concentration as low as possible so as to avoid or minimize undesirable local agglomeration of titanium dioxide raw material and produced composite particles at mixing sites.

As the method of mixing an aqueous titanium dioxide slurry with an aqueous Brφnsted acid salt solution, there can be adopted a method of continuously adding an aqueous Brφnsted acid salt solution to an aqueous titanium dioxide slurry, and a method of simultaneously adding an aqueous Brφnsted acid salt solution and an aqueous titanium dioxide slurry into a reacting vessel.

A mixed liquid of an aqueous Brφnsted acid salt solution with an aqueous titanium dioxide slurry preferably has a concentration of titanium dioxide not larger than 5% by mass, more preferably not larger than 3% by mass. When a mixed liquid having a concentration of titanium dioxide exceeding 5% by mass is prepared, titanium dioxide tends to be agglomerated at mixing.

The temperature at which a Brφnsted acid salt reacts with titanium dioxide is preferably not higher than 50° C., more preferably not higher than 30° C. At a reaction temperature higher than 50° C., fine particles are liable to be agglomerated together in a reaction vessel.

The aqueous slurry obtained by the reaction of a Brφnsted acid salt with titanium dioxide can be subjected to a salt-removal treatment. By the removal of excessive salt, the dispersibility of particles in the aqueous slurry is enhanced. The method of salt-removal includes, for example, a method using an ion-exchange resin, a method using electrodialysis, a method using an ultrafiltration membrane and a method using a rotary filter press which is available, for example, from Kotobuki Giken K.K.

In general, if a compound having no photo-catalytic activity is present on the surface of titanium dioxide particle, the photo-catalytic activity of titanium dioxide is reduced. It is surprising, however, that smaller particles comprised of titanium dioxide having, supported on the surfaces thereof, a compound having no photo-catalytic activity according to the present invention, exhibit enhanced photo-catalytic activity as compared with smaller particles comprised of untreated titanium dioxide. This beneficial effect is obtained in the case when the whole process of the above-mentioned surface treatment of titanium oxide particle Is carried out under conditions such that undesirable agglomeration of titanium dioxide particles and the resulting composite particles can be avoided or minimized. Especially when the titanium dioxide particles are partially surface-treated with a polybasic acid salt, the above-mentioned beneficial effect is markedly manifested. The reason for which is not clear, but it is presumed that a plurality of electron-absorbing carboxyl groups or sulfonyl groups exhibit mutual function prefentially to specific titanium atoms on the particle surface, and consequently electrons produced in the titanium dioxide particles upon irradiation with light are subject to charge transfer, with the result of enhancement in the photo-catalytic activity.

It is also presumed that energy level of a specific titanium-containing composite oxide is newly formed on the surface of titanium dioxide particle, and some of the composite oxide can possess a band gap responsible to visible light rays.

It is generally believed that, in the case when titanium dioxide particles are surface-treated with a compound having no photo-catalytic activity, the photo-catalytic activity of titanium dioxide is deteriorated. This is not always true. Further, it is to be noted that a chemical group having introduced onto the titanium oxide surface by the surface treatment with the compound having no photo-catalytic activity has an end atomic group moiety exhibiting no photo-catalytic activity, and therefore, when the surface-treated titanium dioxide particles are incorporated with an organic material, the end atomic group moiety sterically prevents the contact of the organic material with titanium dioxide, and therefore, a structure composed of the surface-treated titanium dioxide particles and the organic material has enhanced durability. More specifically it is to be noted that the contact of the surface-treated titanium dioxide particles with a solid organic material can be sterically hindered, but, a material to be decomposed by the structure composed of the surface-treated titanium dioxide particles and the organic material is gaseous or liquid and has a high mobility, and therefore, the contact of titanium dioxide with the material to be decomposed can be easily obtained. This leads to the above-mentioned compatibility of high photo-catalytic activity with enhanced durability.

That is, by the surface-treating process of titanium dioxide wherein good dispersion of titanium dioxide particles is kept without agglomeration, a desired mutual action can be obtained between the polybasic acid salt and specific titanium atoms on the particle surface, with the result of the above-mentioned compatibility of photo-catalytic activity higher than that of untreated titanium dioxide particles, with enhanced durability or weather resistance.

The child particles comprised of titanium dioxide particles and, supported thereon, a Brφnsted acid salt can be taken as a powder prepared by drying the particles obtained by the above-mentioned surface treating process. The powder is liable to be agglomerated, and therefore, is usually pulverized by an airflow pulverizer such as a jet mill or a micronizer, or a roller mill or a pulperizer.

The mother particle has an average particle diameter in the range of 2 to 200 μm, preferably 3 to 100 μm, and more preferably 3 to 80 μm, as measured by the laser diffraction-scattering particle size measuring method. When the mother particle has this size, it is advantageous to support the particle on the surface of a base material or structure. If the mother particle has a smaller size, it is difficult to handle and support the particle on the surface thereof. In contrast, if the mother particle has a larger size, the surface of base material or structure having the particle supported thereon is rough and not smooth.

By the term “particle diameters” of mother particle (larger particle) and child particles (smaller particles) in the composite particle of the present invention, as used in this specification, we mean not the particle diameters of mother particle and child particles as measured before the preparation of the composite particle, but, the particle diameters of mother particle and child particles as measured after the preparation of the composite particle. Therefore, the mother particle as measured before it is pulverized and mixed for processing into the composite particle may have a size larger than a diameter of 200 μm. The child particles as measured before the preparation of the composite particle may also have a size larger than a diameter of 0.5 μm, but usually the child particles as measured after the preparation of composite particle have approximately the same size as that as measured before the preparation of composite particle.

The mother particle may be a spherical resin particle. Spherical particles are beneficial in that, at the step of preparing composite particles including the step of treating, for example, by a ball mill, undesirable packing of particles to an excessive extent and sticking occurring among particles to be made Into composite particles or between such particles and mixing media such as balls can be easily avoided.

The mother particle preferably has a melting point of at least 150° C. In the case when a composite particle made from the mother particle having such a high melting point is blended and kneaded together with another resin to form a molding at a high temperature, the mother particle has good shape retention and therefore the performance of the child particles of the composite particle in the molding can be manifested to a sufficient extent.

The mother particle can be comprised of a hydroxide, oxide or carbonate, which contains at least one kind of element selected from the group consisting of aluminum, magnesium, calcium and silicon. Preferable examples of the mother particle are particles of a hydroxide or oxide of aluminum, magnesium or calcium, particles of a carbonate of calcium, and particles of silica. As specific examples of the mother particle, there can be mentioned particles of aluminum hydroxide, magnesium hydroxide, calcium hydroxide, aluminum oxide, magnesium oxide, calcium oxide, calcium carbonate and silica. The mother particle may be a composite of two or more of these particles.

The shape of mother particle and the method of preparing mother particle are not particularly limited, provided that the mother particle has the above-specified particle diameter.

When the above-mentioned mother particle and the child particle containing, for example, silica or a Brφnsted acid salt are subjected to mixing, pulverizing and stirring under specific conditions, the mother particle can be strongly bonded to silica or a Brφnsted acid salt of the child particles. That is, in the case when the mother particle and the child particles are dry-mixed together by a ball mill under conditions such that k value as defined by the equation (1) below is in the range of 50 to 50,000; or are subjected to mixing, pulverizing and stirring by a powder-treating apparatus provided with rotary blades under conditions such that k2 value as defined by the equation (2) below is in the range of 250 to 50,000; or are subjected to mixing, pulverizing and stirring by a shaking-type powder-treating apparatus under conditions such that k3 value as defined by the equation (3) below is in the range of 50 to 50,000; a composite particle wherein the mother particle is strongly bonded to the child particles can be obtained.

When the mother particle (larger particle) and the child particles (smaller particles) are made into a composite particle, the child particles and the mother particle or a precursor particle for the mother particle are mixed, pulverized and stirred with a predetermined energy constant. A mixing medium for mixing, pulverizing and stirring gives impact energy, frictional energy and shearing energy to the particles whereby the surfaces of particles are activated to form a composite particle.

The means for mixing, pulverizing and stirring for forming a composite particle includes various mixing and pulverizing means, and mechanical melt-processing means. For example, a rolling ball mill, a high-speed rotary pulverizer, a mixing medium-stirring mill, a high-speed airflow impact pulverizer, and a surface-melting apparatus can be used. Operating factors for giving adequate impact energy, frictional energy and shearing energy to particulate materials include, for example, number of revolution and residence time for a high-speed rotary pulverizer; rate of stirring, mass of mixing media and stirring time for a mixing medium-stirring mill; and pressure of carrier gas and residence time for a high-speed airflow impact pulverizer.

A ball mill, which is a most popular mixing and pulverizing apparatus, is preferable for forming a composite particle because a constant energy can be given to particles by appropriately choosing operating factors. Energy constant k can be a measure for the energy consumed for the formation of a composite particle. Energy constant k as defined by the equation (2) below has been proposed as a measure for evaluating the mixing and pulverizing effect of a rolling ball mill (L. D. Hart and L. K. Hadson, The American Ceramic Society Bulletin, 43, No. 1 (1964).
k=(wm/wp)×d×n×t Equation (1):
where k is energy constant,

wp is total mass (g) of particles to be mixed,

wm is mass (g) of mixing media,

d is Inner diameter (m) of ball mill,

n is number of rotation (rpm) of ball mill, and

t is time (min) for mixing.

In the case when mixing, pulverizing and stirring are carried out by a powder-treating apparatus provided with rotary blades, the energy constant is expressed by a k2 value as defined by the following equation (2).
k2=n×t Equation (2):
where n is number of rotation (rpm) of rotary blades, and

t is time (min) for mixing, pulverizing and stirring.

In the case when mixing, pulverizing and stirring are carried out by a shaking-type powder-treating apparatus, the energy constant is expressed by a k3 value as defined by the following equation (3).
k3=n×t Equation (3):
where n is number of shaking per minute, and

t is time (min) for mixing.

In any cases, as the energy constant is larger, the energies of impact, friction and shear are larger and the bonding force between the mother particle and the child particles is enhanced.

In the process for preparing a composite particle of the present invention, when an apparatus giving energy to particles by rolling a pulverizing and mixing medium, such as a ball mill, is used, the energy constant k for mixing, pulverizing and stirring the mother particle and the child particles, as defined by the equation (1) is in the range of 50 to 50,000, preferably 750 to 20,000, and more preferably 1,000 to 15,000.

When an apparatus giving energy to particles by rotary blades is used, the energy constant k2 as defined by the equation (2) is in the range of 250 to 50,000, preferably 500 to 20,000, and more preferably 700 to 15,000.

When an apparatus giving energy to particles by shaking of a medium for mixing and pulverization is used, the energy constant k3 as defined by the equation (3) is in the range of 50 to 50,000, preferably 250 to 20,000, and more preferably 700 to 15,000.

If the energy constant is smaller than the above-specified lower limits, the surfaces of particles cannot be activated to the desired extent and the bonding of particles are insufficient. In contrast, if the energy constant is larger than the respective upper limits, pulverization proceeds to a great extent and the particles become very fine, and the particle surfaces are greatly activated, with the result that bonding of particles occurs to an undue extent and coarse particles are formed. Further, if the energy constant is too large, the activated particles tend to stick to a pulverizing medium and to the inner wall of a vessel.

The apparatus used for the formation of the composite particle is not particularly limited, and includes, for example, a conventional ball mill, a powder-treating apparatus provided with rotary blades such as a super-mixer available from K.K. Kawata, a shaking-type powder treating apparatus such as a paint-shaker available from Asada Tekkou K.K., Hybridization System available from Nara Kikai Mfg. Co., Mechanofusion™ available from Hosokawa Micron K.K., a medium-flow dryer, an airflow impact apparatus and a surface-melting apparatus.

Means for forming the composite particle, other than the above-mentioned rolling ball mill type, rotary blade type and shaking type apparatuses, can also be used. In this case the energy required for formation of the composite particle should be adequately controlled so that the power per unit mass of particulate materials is approximately the same as those corresponding to the magnitude of energy constant k in the case when a ball mill is used.

In the case when smaller particles in the form of slurry comprised of titanium dioxide particles and, supported on the surfaces thereof, a Brφnsted acid salt are combined with a larger particle to form a composite particle, the larger particle can be incorporated in the slurry of smaller particles, and then the mixed slurry is placed in and treated by a medium-flow drying apparatus. By adding the mixed slurry in a ceramic medium in a flow state, the shearing force of the media at mixing and the agglomerating force at drying apply whereby the larger particle and the smaller particles are firmly bonded together.

The proportion of the smaller particles to the larger particle placed in an apparatus for forming the composite particle is such that the amount of smaller particles is in the range of 0.5% by mass to 40% by mass of the larger particle.

The composite particle of the present invention can be used in fields similar to those of conventional titanium dioxide. For example, the composite particle is used for resin articles, rubber articles, paper, cosmetics, paints, printing inks, ceramic articles, dye sensitizing solar batteries, and photo-catalysts.

The composite particle of the present invention can be used in combination with an organic polymer. The organic polymer includes, for example, synthetic thermoplastic resins, synthetic thermosetting resins and natural resins. As specific examples of the organic high polymer, there can be mentioned polyolefins such as polyethylene, polypropylene and polystyrene; polyamides such as nylon 6, nylon 66 and aramide; polyesters such as polyethylene terephthalate and unsaturated polyesters; polyvinyl chloride, polyvinylidene chloride, polyethylene oxide, polyethylene glycol, silicone resin, polyvinyl alcohol, vinyl acetal resin, polyacetate, ABS resin, epoxy resin, vinyl acetate resin, cellulose and rayon and other cellulose derivatives, polyurethane, polycarbonate, urea resin, fluororesin, polyvinylidene fluoride, phenolic resin, celluloid, chitin, starch sheet, acrylic resin, melamine resin and alkyd resin. These organic polymers may be used either alone or as a combination of at least two thereof.

The organic polymer composition comprising the composite particle of the present invention can be used for example, as a coating or paint composition, a compound (powder-containing resin composition), and a master batch containing the composite particle at a high concentration for use, for example, in molding. Additives such as an antioxidant, an antistatic agent and a fatty acid metal salt can be incorporated in the organic polymer composition.

The amount of the composite particle of the present invention is preferably in the range of 0.01% to 80% by mass, more preferably 0.01% to 60% by mass, especially preferably 1% to 50% by mass and most preferably 1% to 40% by mass, based on the total mass of the organic polymer composition.

By shaping the organic polymer composition, a shaped article having an ultraviolet rays-screening performance can be obtained. Such shaped article includes, for example, fiber, film and plastic moldings.

The fiber includes, for example, polyolefin fiber, polyamide fiber, polyester fiber, acrylic fiber and rayon. These fibers can be made into various textile articles having a photo-catalytic activity. As specific examples of the textile article, there can be mentioned clothes such as towel, dish cloth, hand-wiping cloth, glasses-wiping cloth and handkerchief; bedding clothes and other clothes such as pajamas, diaper, bed sheet, toilet seat cover, blanket and futon (quilt); under wears and hoses; sanitary and hospital clothes such as mask, white garment, nurse cap, curtain and bed sheet; sports wear and other sports goods such as supporter, training wears and jersey clothes; automobile clothes such as automobile seat, seat cover, automobile ceiling and automobile floor; home clothes such as carpet, curtain, mat, decorative hanging cloth, and chair cloth and sofa cloth; and clothing such as sweater. Further, the fiber can be made into paper goods such as wall paper or cloth and sliding door paper or cloth.

As specific examples of the film, there can be mentioned waste bag film, food packing film, wrapping film, shrink film for PET bottle, and cosmetic film or cosmetic board.

As specific examples of the molding, there can be mentioned wash stand unit, bath unit, plastic part of kitchen unit, plastic part of hand rail, television set, personal computer, indoor air-conditioner, copying machine, washing machine, dehumidifier, telephone set, electrical-pot and plastic body of electrical cleaner, plastic cover of lighting appliance, plastic hanger, plastic dress container, plastic waste box, and automobile dashboard.

In a shaped article made from the organic polymer composition comprising the composite particle of the present invention, the mother particle is partially exposed on the surface of shaped article. In the case when the organic polymer composition is shaped into fiber or film, the fiber diameter and the film thickness are not particularly limited. However, the fiber diameter and the film thickness are preferably in the range of 2 to 200 times, more preferably 5 to 100 times of the average particle diameter of the mother particle.

The composite particle of the present invention can be dispersed in water or an organic solvent, and if desired, a binder is added to prepare a coating composition. The binder used is not particularly limited, and may be either an organic binder or inorganic binder.

As specific examples of the organic binder, there can be mentioned polyvinyl alcohol, melamine resin, urethane resin, celluloid, chitin, starch sheet, polyacrylamide, polyester such as unsaturated polyester, polyvinyl chloride, polyvinylidene chloride, polyethylene oxide, polyethylene glycol, silicone resin, vinyl acetal resin, epoxy resin, vinyl acetate resin, polyurethane, urea resin, fluororesin, polyvinylidene fluoride and phenolic resin. As specific examples of the inorganic binder, there can be mentioned zirconium compounds such as zirconium oxychloride, zirconium hydroxychloride, zirconium nitrate, zirconium sulfate, zirconium acetate, zirconium ammonium carbonate and zirconium propionate; silicon compounds such as alkoxysilanes and silicates; and metal alkoxides such as aluminum alkoxides and titanium alkoxides.

The amount of binder in the coating composition is preferably in the range of 0.01% to 20% by mass, more preferably 1% to 10% by mass based on the mass of the coating composition. If the amount of binder is smaller than 0.01% by mass, a resulting coating does not exhibit a sufficient adhesion. In contrast, if the amount of binder exceeds 20% by mass, the coating composition is undesirably thickened and not advantageous from cost consideration.

The composite particle of the present invention can be provided or adhered onto the surface of a structure. The structure used is not particularly limited, and includes, for example, those comprised of an inorganic material such as metal, concrete, glass or pottery; or an organic material such as paper, plastic material, wood or leather; or a combination of two or more thereof. As specific examples of the structure, there can be mentioned building materials, machines, vehicles, glass articles, electrical appliances, agricultural materials, electronic parts and instruments, tools, tableware, bathroom fittings and accessories, toilet fittings and requisites, furniture, clothes, fabrics, fibers, leather articles, paper products, sports goods, futon (quilt), vessels and containers, glasses, sign-boards, piping, fitment, sanitary materials, automobile parts, outdoor goods such as tent, stockings, hosiery, gloves and masks. The structure further includes environmental cleaning or environmental damage-preventing equipments and instruments, which are used for a remedy for sick houses, decomposition of harmful organic chlorine-containing compounds such as polychlorobiphenyl (PCB) and dioxin present in water, air or soil, and decomposition of residual pesticide present in water or soil and environmental hormone.

As examples of the light source for emission for developing with enhanced efficiency the photo-catalytic-activity or hydrophilic property of the structure comprising the composite particle on a surface thereof, there can be mentioned sun, fluorescent lighting, incandescent lamp, mercury lamp, xenon lamp, halogen lamp, mercury xenon lamp, metal halide lamp, light emitting diode, laser and burning flame of organic material. The fluorescent lighting includes, for example, cool white fluorescent lamp, white daylight fluorescent lamp, daylight fluorescent lamp, warm white fluorescent lamp, incandescent lamp-light fluorescent lamp and black light lamp.

The method of preparing the structure comprising the composite particle on the surface thereof is not particularly limited, and includes, for example, a method of directly coating a structure with the above-mentioned organic polymer composition or the above-mentioned coating composition, or a method of coating a structure having a coating on the surface thereof with the above-mentioned organic polymer composition or the above-mentioned coating composition. In the case when a structure is coated with the coating composition to form a filmy coating, it is possible that a composite particle Is partially exposed on the surface of film. In this case, the thickness of film is preferably in the range of 2 to 200 times, more preferably 5 to 100 times of the average particle diameter of mother particle.

The coated structure may be further coated with another coating composition. In this case, it is preferable that the film formed by coating does not cover the area in which the composite particle is exposed, or a material to be decomposed by the photo-catalytic activity is capable of permeating through the film formed by coating.

The composite particle of the present invention can be used in cosmetics. A composite particle comprised of a mother particle and child particles which are titanium-silica composite particles is especially preferable for use in cosmetics. The cosmetics containing this composite particle are advantageous over those which contain only the child particles, i.e., titanium-silica composite particles. The cosmetics containing this composite particle smoothes the skin when applied to the skin. This advantage is more marked in the case when the mother particle is comprised of a spherical nylon particle. That is, the composite particle comprising a spherical nylon mother particle and, supported thereon, titanium dioxide-silica composite particles as child particles exhibits good smoothness and feeling when applied to the skin, and has good ultraviolet rays-screening performance.

Various additives can be incorporated in the cosmetics. The additives include those which are conventionally used, and, as examples thereof, there can be mentioned oils, whitening agents, humectants, anti-aging agents, emollients, extracts and essences, anti-inflammatory agents, antioxidants, surface active agents, chelating agents, anti-fungus agents, antiseptics, amino acids, saccharides, organic acids, alcohols, esters, oils and fats, hydrocarbons, ultraviolet ray-absorbers and inorganic powders.

As specific examples of the additives, there can be mentioned solvents such as ethanol, isopropanol, butyl alcohol and benzylalcohol; polyhydric alcohols such as glycerine, propylene glycol, sorbit, polyethylene glycol, dipropylene glycol, 1,3-butylene glycol and 1,2-pentanediol; saccharides such as sorbitol; disaccharides such as trehalose; humectants such as hyaluronic acid and water-soluble collagen; hydrated squalane, vegitable oils such as olive oil and Simmondsia chinensis oil; emollients such as aeramide; stabilized ascorbic acid such as magnesium ascorbate phosphate and ascorbic acid glucoside; whitening agents such as arbutin, kojic acid, ellagic acid, rucinol and camomille essence; anti-inflammatory agents such as allantoin, glycylrhetinic acid and its salts; nonionic surface active agents such as monostearic acid glyceride, polyoxyethylene (POE) sorbitan fatty acid esters, sorbitan fatty acid ester, polyoxyethylene (POE) alkyl ether, POE-POP block polymer and POE hardened castor oil ester; anionic surface active agents such as fatty acid soaps and sodium alkylsulafates; hydrocarbons such as squalane, fluid paraffin, paraffin, isoparaffin, vaseline and α-olefin oligomer; oils and fats such as almond oil, cocoa butter, macadamia nut oil, avocado oil, castor oil, sunflower oil, evening primrose oil, safflower oil, rape seed oil, horse oil, tallow and synthetic triglyceride; waxes such as beeswax, lanolin and Simmondsia chinensis oil; fatty acids such as lauric acid, stearic acid, oleic acid, isosteario acid, myristic acid, palmitic acid, behenic acid, glycolic acid and tartaric acid; higher alcohols such as cetanol, stearyl alcohol, behenyl alcohol and octyldodecyl alcohol; synthetic esters such as glycerine triester and pentaerythrithol tetraester; silicone oils such as dimethyl polysiloxane and methylphenyl polysiloxane; chelating agents such as ethylenediaminetetraacetic acid (EDTA), gluconic acid, phytic acid and sodium polyphosphate; antiseptics such as p-hydroxybenzoic acid esters, sorbic acid, isopropylmethyl-phenol, aresol, benzoic acid, ethyl benzoate, chlorostearyldimethylbenzyl ammonium, hinokitiol, furfural and sodium pyrithioate; bactericides; antioxidants such as vitamin-E, dibutylhydroxytoluene, sodium hydrogensulfite and butylhydroxyanisole; buffering agents such as citric acid, sodium citrate, lactic acid and sodium lactate; amiono acids such as glycine and alanine; esters such as butyl myristate, ethyl oleate and ethyl stearate; perfumes; pigments; animal extracts and vegetable extracts; vitamins such as vitamin A, vitamin B and vitamin C, and derivatives thereof; ultraviolet absorbers such as p-aminobenzoic acid, octyl p-dimethylaminobenzoate, ethyl p-aminobenzoate, phenyl salicylate, benzyl cinnamate, octyl methoxycinnamate, cinoxate, ethyl urocanate, hydroxymethoxybenzophenone and dihydroxybenzophenone; inorganic powders such as mica, talc, kaoline, calcium carbonate, silicic anhydride, aluminum oxide, magnesium carbonate, barium sulfate, cerium oxide, red iron oxide, chromium oxide, ultramarine, black iron oxide and yellow iron oxide; and resin powders such as nylon powder and polymethyl methacrylate powder.

The procedures and conditions for preparation of the cosmetics may be the same as those which are conventionally adopted in cosmetic industry except for the procedures and conditions for preparation of the composite particle of the present invention.

### EXAMPLES

The invention will be described by the following examples that by no means limit the scope of the invention.

The methods of evaluation adopted in the following examples and comparative examples are as follows.

(1) Photo-Catalytic Performance of Film

20 parts by mass of a composite particle of the present invention, 2 parts by mass of zinc stearate (“Zinc stearate S” available from NOF Corporation) and 78 parts by mass of low density polyethylene (“J-REX™ JH607C, available from Japan Polyolefins Corporation) were melted and kneaded together by a twin screw extruder (KZW15-30MG, available from Technovel Corporation) at 140° C. for a residence time of about 3 minutes to prepare a pellet. The pellet was comprised of a low density polyethylene compound containing 20% of the composite particle, and each pellet had a columnar shape having a diameter of 2 to 3 mm and a length of 3 to 5 mm, and a mass of 0.01 to 0.02 g.

4 kg of the above-mentioned composite particle-containing low density polyethylene compound was mixed together with 16 kg of low density polyethylene (“J-REX™ JH607C, available from Japan Polyolefins Corporation) by a V-type blender (“RKI-40” available from Ikemoto Rika Kogyo K.K.) for 10 minutes to prepare a mixed pellet.

The mixed pellet was melt-extruded by a twin screw kneading extruder equipped with a 200 mm T-die (KZW15-30MG, available from Technovel Corporation) at a die temperature of 250° C. to make a film with a thickness of 80 μm.

A test ink was dropped on the film so that the ink was spread into a circle having a diameter of about 2 cm to prepare a specimen for color-fading test. The test ink was a solution of 1 g of an ink for color printer (BJI201M-Magenta, available from Canon Inc.) in 99 g of ethanol.

The color-fading test specimen was placed 5 cm apart from a glass window. The specimen was irradiated with sunlight through the window, and color-fading was observed by the naked eye after accumulated three days of fine weather elapsed.

(2) Hydrogen Sulfide Deodorizing Test

A specimen in an amount such that the total area-of photo-catalytic surface was 400 cm² was placed in a 5 liter “Tedlar™ bag (AAK-5 available from GL Sciences Inc.). Then 5 liters of dry air containing 60 ppm by volume of hydrogen sulfide was blown into the bag at least one time, and thereafter, 5 liters of dry air containing 60 ppm by volume of hydrogen sulfide was blown into the bag whereby the inner gas was thoroughly substituted. The dry air containing 60 ppm by volume of hydrogen sulfide was prepared by permeator (PD-1B, available from Gastec Corporation) using a commercially available compressed air.

The initial concentration of hydrogen sulfide C_{0T} (ppm by volume) was measured by an indicator tube (No. 4LL, available form Gastec Corporation). The specimen was irradiated with ultraviolet rays through the bag wall so that ultraviolet rays having an intensity of 0.5 mW/cm² at 365 nm were incident on the photo-catalytic surface. When 4 hours elapsed from the commencement of irradiation, the concentration of hydrogen sulfide C_{1T} (ppm by volume) within the bag was measured. For a control test, a similar test was conducted wherein the specimen-containing bag was allowed to stand for 4 hours in the dark place. The initial concentration of hydrogen sulfide and the concentration of hydrogen sulfide as measured after 4 hours standing were C_{0S} (ppm by volume) and C_{1B} (ppm by volume), respectively.

As a light source, black light lamp (FL20S-BL-B, available from National K.K.) was used. The intensity of light at 365 nm was measured by an ultraviolet light quantity integrating meter (UIT-150 available from Ushio Inc.). In the case when a white daylight fluorescent lamp was used as a light source, High White FL20SS-N/18-B available from Hitachi GE Lighting Co. was used. The intensity of light at 365 nm was measured by UVA-365 available from ATEX CORPORATION was used. By this measuring apparatus, a weak light intensity at 365 nm could be measured. More specifically the light irradiation test was conducted so that ultraviolet rays having an intensity of 6 μW/cm² at 365 nm were Incident on the photo-catalytic surface by the white daylight fluorescent lamp.

The rate of decomposition D₁ of hydrogen sulfide except for adsorption is defined by the following equation.
D₁={(C_{0T}−C_{1T})−(C_{0S}−C_{1B})}/C_{0T}×100(%)
As D₁ is larger, the photo-catalytic performance is larger.
(3) Weathering Test (Weather Resistance of Film)

A part of the film specimen prepared for the ink color-fading test was used for the weathering test. The specimen was exposed for 48 hours to light using Sunshine Super-Long-Life Weather Meter Type WEL-SUN-HCH available from Suga Test Instruments Co., Ltd. The weathering test was conducted according to JIS K7350-4 (Plastic—Weathering Test Method Using Laboratory LightSource—OpenFlame CarbonArcLamp) using I-type filter under conditions of black panel temperature: 63±3° C. and water spraying time: 18±0.5 minutes/60 minutes.

Gloss of film was measured before and after the film specimen was exposed to light using Sunshine Super-Long-Life Weatherometer. The measurement was carried out by GLOSS CHECKER IC-320 available from Horiba Ltd. Gloss retention was calculated by the following equation.
Gloss retention=BL₁/BL₀×100(%)
where BL₀ (%) is gloss of film as measured before light exposure test, and BL₁ (%) is gloss of film as measured after light exposure test.
(4) Evaluation of Mixed Crystal State

The mixed crystal state of child particles was evaluated by X-ray photoelectron spectroscopy (XPS). The details of XPS is described, for example, in A. Yu. Stakheev et al, J. Phys. Chem., 97(21), 5668-5672 (1993).

### Example 1

A gaseous titanium tetrachloride having a concentration of 100% by volume and a gaseous silicon tetrachloride having a concentration of 100% by volume were mixed together at a rate of 9.4 Nm³/hour and 0.25 Nm³/hour, respectively, and the mixed gas was heated to 1,000° C. Oxygen gas and water vapor were mixed together at rate of 8 Nm³/hour and 20 Nm³/hour, respectively, and the mixed gas was heated to 1,000° C. The two kinds of mixed gases maintained at that temperature were fed at a flow rate of 49 m/second and 60 m/second, respectively, through a co-axial parallel flow nozzle into a reaction tube so that the titanium tetrachloride-silicon tetrachloride mixed gas flows through the inner tube of the coaxial parallel flow nozzle. The reaction tube had an inner diameter of 100 mm. The calculated flow rate in the reaction tube at a reaction temperature of 1,300° C. was 10 m/second.

Cool air was introduced into the reaction tube so that the residence time at a high temperature within the reaction tube is not larger than 3 seconds. Ultra-fine particles in the reaction product were collected by a polytetrafluoroethylene bag filter, and the thus-collected powder was dried at 500° C. for 1 hour in an air atmosphere in an oven, and dechlorination treatment was carried out.

The thus-obtained mixed crystal oxide ultra-fine particles had a BET specific surface area of 24 m²/g, a SiO₂ content of 2.2% by mass and a chlorine content of 0.01% by mass, and had an average primary particle diameter of 0.06 μm as calculated from the BET specific surface area. XPS revealed the existence of a titanium-oxygen-silica bond. The mixed crystal oxide ultra-fine particles were used as child particles for the preparation of a composite particle as follows.

800 g of alumina balls having a diameter of 5 mm were placed in a nylon vessel having a diameter of 12.5 cm. 190 g of aluminum hydroxide particles having an average diameter of 85 μm (“Hygilite™ H-10 available from Showa Denko K.K.) and 10 g of titanium dioxide-silica composite fine particles prepared by the above-mentioned process (average primary particle diameter as calculated from BET specific surface area; 0.06 μm, SiO₂ content: 2.2% by mass) were placed in the nylon vessel. The lid of the vessel was shut down, and the content was mixed and pulverized at 50 rpm for 2 hours. The energy constant was 3,000.

After completion of the mixing and pulverization, the content was observed by scanning electron microscope. It was found that free fine particles are present only in a very minor amount and the most part of particles were a composite particle. It was confirmed that the composite particle was comprised of a mother particle and, supported on the surface thereof, titanium, dioxide-silica composite fine particles as a child particles. The mother particle of the composite particle was an aluminum hydroxide particle having an average diameter of about 60 μm as measured by the laser diffraction-scattering particle size measuring method. Thus, the particle size of the aluminum hydroxide particle was reduced only to a minor extent. The diameter of the titanium dioxide-silica composite fine particles as calculated from BET specific surface area was the same as that as measured before made Into the mother-child composite particle.

A film specimen was prepared from the mother-child composite particle by the method mentioned above, and an ink color-fading test was conducted. The magenta color substantially disappeared. In contrast, when a control test was conducted in a dark place for the same time, the magenta color was not faded. Thus, the disappearance of magenta color in the film specimen according to the present invention was proved to be due to the photo-catalytic effect. The film exhibited a gloss retention of 90%, and the decomposition D₀ of hydrogen sulfide except for adsorption was 40%.

### Example 2

800 g of alumina balls having a diameter of 5 mm were placed in a nylon vessel having a diameter of 12.5 cm. 190 g of aluminum hydroxide particles having an average diameter of 9 μm as measured by the laser diffraction-scattering particle size measuring method (“Hygilite™ HS-320 available from Showa Denko K.K.) and 10 g of the titanium dioxide-silica composite fine particles prepared in Example 1. The lid of the vessel was shut down, and the content was mixed and pulverized at 50 rpm for 30 minutes, The energy constant was 750.

After completion of the mixing and pulverization, the content was observed by scanning electron microscope. It was found that free fine particles are present only in a very minor amount and the most part of particles were a composite particle. It was confirmed that the composite particle was comprised of a mother particle and, supported on the surface thereof, titanium dioxide-silica composite fine particles as child particles. The particle diameter of the aluminum hydroxide mother particle as measured by the laser diffraction-scattering particle size measuring method was approximately the same as that as measured before made into the mother-child composite particle. The particle diameter of the titanium dioxide-silica composite fine particles as calculated from BET specific surface area was the same as that as measured before made into the mother-child composite particle.

A film specimen was prepared from the mother-child composite particle by the method mentioned above, and an ink color-fading test was conducted. The magenta color substantially disappeared. In contrast, when a control test was conducted in a dark place for the same time, the magenta color was not faded. Thus, the disappearance of magenta color in the film specimen according to the present invention was proved to be due to the photo-catalytic effect. The film exhibited a gloss retention of 80%, and the decomposition D₀ of hydrogen sulfide except for adsorption was 60%.

### Example 3

800 g of alumina balls having a diameter of 5 mm were placed in a nylon vessel having a diameter of 12.5 cm. 190 g of nylon powder comprised of spherical particles having an average particle diameter of 10 μm and a melting point of 165° C. (“KG-100” available from Toray Industries Inc.) and 10 g of the titanium dioxide-silica composite fine particles prepared in Example 1. The lid of the vessel was shut down, and the content was mixed and pulverized at 50 rpm for 8 hours. The energy constant was 12,000.

After completion of the mixing and pulverization, the content was observed by scanning electron microscope. It was found that free fine particles are present only in a very minor amount and the most part of particles were a composite particle. It was confirmed that the composite particle was comprised of a nylon mother particle and, supported on the surface thereof, titanium dioxide-silica composite fine particles as child particles. The particle diameter of the nylon mother particle as measured by the laser diffraction-scattering particle size measuring method was approximately the same as that as measured before made into the mother-child composite particle. The particle diameter of the titanium dioxide-silica composite fine particles as calculated from BET specific surface area was the same as that as measured before made into the mother-child composite particle.

A film specimen was prepared from the mother-child composite particle by the method mentioned above, and an ink color-fading test was conducted. The magenta color substantially disappeared. In contrast, when a control test was conducted in a dark place for the same time, the magenta color was not faded. Thus, the disappearance of magenta color in the film specimen according to the present invention was proved to be due to the photo-catalytic effect. The film exhibited a gloss retention of 85%, and the decomposition D₀ of hydrogen sulfide except for adsorption was 55%.

### Example 4

Super-mixer SMG-100 having a volume of 100 liters (available from K.K. Kawata) was charged with 27 kg of calcium carbonate having an average particle diameter of 14 μm as measured by the laser diffraction-scattering particle size measuring method (“Whiton B” available from Shiraishi Calcium Kaisha Ltd.). Then 3 kg g of the titanium dioxide-silica composite fine particles prepared in Example 1 was added. The lid of the vessel was shut down, and the content was mixed and pulverized at 1,500 rpm for 3 minutes at room temperature. The energy constant k2 was 4,500.

After completion of the mixing and pulverization, the content was observed by scanning electron microscope. It was found that free fine particles are present only in a very minor amount and the most part of particles were a composite particle. It was confirmed that the composite particle was comprised of a calcium carbonate mother particle and, supported on the surface thereof, titanium dioxide-silica composite fine particles as child particles. The particle diameter of the calcium carbonate mother particle as measured by the laser diffraction-scattering particle size measuring method was approximately the same as that as measured before made into the mother-child composite particle. The particle diameter of the titanium dioxide-silica composite fine particles as calculated from BET specific surface area was the same as that as measured before made into the mother-child composite particle.

A film specimen was prepared from the mother-child composite particle by the method mentioned above, and an ink color-fading test was conducted. The magenta color substantially disappeared. In contrast, when a control test was conducted in a dark place for the same time, the magenta color was not faded. Thus, the disappearance of magenta color in the film specimen according to the present invention was proved to be due to the photo-catalytic effect. The film exhibited a gloss retention of 85%, and the decomposition D₀ of hydrogen sulfide except for adsorption was 50%.

### Example 5

Paint-shaker having a volume of 5 liters (available from Asada Tekkou K.K.) was charged with 1.5 kg of calcium carbonate having an average particle diameter of 14 μm as measured by the laser diffraction-scattering particle size measuring method (“Whiton B” available from Shiraishi Calcium Kaisha Ltd.). Then 200 g of the titanium dioxide-silica composite fine particles prepared in Example 1 was added. The lid of the vessel was shut down, and the content was mixed and pulverized for 3 minutes at room temperature. The energy constant k3 was about 600.

After completion of the mixing and pulverization, the content was observed by scanning electron microscope. It was found that free fine particles are present only in a very minor amount and the most part of particles were a composite particle. It was confirmed that the composite particle was comprised of a calcium carbonate mother particle and, supported on the surface thereof, titanium dioxide-silica composite fine particles as child particles. The particle diameter of the calcium carbonate mother particle as measured by the laser diffraction-scattering particle size measuring method was approximately the same as that as measured before made into the mother-child composite particle. The particle diameter of the titanium dioxide-silica composite fine particles as calculated from BET specific surf ace area was the same as that as measured before made into the mother-child composite particle.

A film specimen was prepared from the mother-child composite particle by the method mentioned above, and an ink color-fading test was conducted. The magenta color substantially disappeared. In contrast, when a control test was conducted in a dark place for the same time, the magenta color was not faded thus, the disappearance of magenta color In the film specimen according to the present invention was proved to be due to the photo-catalytic effect. The film exhibited a gloss retention of 80%, and the decomposition D₀ of hydrogen sulfide except for adsorption was 65%.

### Example 6

50 liters of pure water as previously metered (“liter” is hereinafter abbreviated to as “L”) was heated to 98° C. with stirring. At that temperature, 3.6 kg of an aqueous titanium tetrachloride (available from Sumitomo Titanium K.K.) solution having a titanium concentration of 15% by mass was dropwlse added over a period of 120 minutes. Thus-obtained white turbid slurry was subjected to electric dialysis to be thereby dechlorinated to obtain a slurry having a pH value of 4. A part of the slurry was taken and the solid content was measured by a dry constant mass method. The sold content was 2% by mass.

X-ray diffraction analysis of the dry powder revealed that the powder was predominantly comprised of brookite titanium dioxide. More specifically the dry powder contained 89% by mass of brookite titanium dioxide and 11% by mass of anatase titanium dioxide.

100 g of sodium pyrophosphate (for food additive, available from Taihei Chem. Ind. Co., Ltd.) was dissolved in pure water to prepare 2 kg of an aqueous sodium pyrophosphate solution having a concentration of 5% by masse.

A reaction vessel was charged with 50 L of the above-mentioned titanium dioxide slurry having a concentration of 2% by mass while being cooled and stirred. Then 2 kg of the aqueous sodium pyrophosphate solution having a concentration of 5% by mass, and an aqueous sodium hydroxide solution having a concentration of 5% by mass were added over a period of 1 hour to prepare an aqueous mixed liquid had a pH value of 8 to 9. The reaction temperature was 20 to 25° C.

The thus-obtained sodium pyrophosphate-containing aqueous titanium dioxide slurry was maintained at 22 to 28° C. for 1 hour. The electric conductivity of the slurry was 10,000 μS/cm. Then the slurry was filtered through a rotary filter press (available from Kotobuki Eng. & Mfg. Co. Ltd.) and washed. Water washing was thoroughly conducted until the electric conductivity of the washed slurry reached 50 μS/cm, and the slurry was concentrated to obtain a photo-catalytic slurry. The photo-catalytic slurry had a pH value of 7.8 as measured pH meter (D-22 available from Horiba Ltd.)

A part of the photo-catalytic slurry was taken and a powder was obtained by a dry constant mass method. The solid content in slurry was 10% by mass. Fourier transform infrared microscope (FT-IR) (FT-IR 1650, available form Perkin-Elmer Co.) analysis of the dry powder revealed the absorbance of pyrophosphate. Atomic emission spectrochemioal analysis (ICP) (ICPS-100V, available from Shimadzu Corporation) of the powder revealed that the contents of Na and phosphorus were 0.7% by mass and 1.2% by mass, respectively. Electrophoresis light scattering analysis using ELS-8000 available from Otsuka Electronics Co., Ltd. to measure ζ-potential revealed that the isoelecric point was 2.1. The BET specific surface area as measured using Flow Sorb II 2300 available from Shimadzu-Corporation was 140 m²/g.

To 10 kg of the above-mentioned photo-catalytic slurry, 70 kg of pure water and 20 kg of calcium carbonate having an average particle diameter of 14 μm as measured by the laser diffraction-scattering particle size measuring method (“Whiton B” available from Shiraishi Calcium Kaisha Ltd.). The mixture was thoroughly stirred, and then dried by a working media-flowing dryer (slurry drier available from Ookawara Mfg. Co.) to prepare a composite particle comprised of a calcium carbonate mother particle, and, supported thereon, child particles comprising fine titanium dioxide particles having a Brφnsted acid salt supported on the surface thereof.

A film specimen was prepared from the mother-child composite particle by the method mentioned above, and an ink color-fading test was conducted. The magenta color substantially disappeared. In contrast, when a control test was conducted in a dark place for the same time, the magenta color was not faded. Thus, the disappearance of magenta color in the film specimen according to the present invention was proved to be due to the photo-catalytic effect. The film exhibited a gloss retention of 80%. The decomposition D₀ of hydrogen sulfide except for adsorption was 75% as measured using a black light lamp as light source.

The decomposition D₀ of hydrogen sulfide except for adsorption was 12% as measured using a white daylight fluorescent lamp as light source. Thus decomposition of hydrogen sulfide occurred even when a weak fluorescent lamp was used.

### Example 7

To 10 kg of the photo-catalytic slurry prepared in Example 6, 150 kg of pure water and 40 kg of calcium carbonate having an average particle diameter of 14 μm as measured by the laser diffraction-scattering particle size measuring method (“Whiton B” available from Shiraishi Calcium Kaisha Ltd.). The mixture was thoroughly stirred, and then dried by the same procedure as mentioned in Example 6 to prepare a composite particle.

A film specimen was prepared from the mother-child composite particle by the method mentioned above, and an ink color-fading test was conducted. The magenta color substantially disappeared. In contrast, when a control test was conducted in a dark place for the same time the magenta color was not faded. Thus, the disappearance of magenta color in the film specimen according to the present invention was proved to be due to the photo-catalytic effect. The film exhibited a gloss retention of 80%. The decomposition D₀ of hydrogen sulfide except for adsorption was 90% as measured using a black light lamp as light source.

The decomposition D₀ of hydrogen sulfide except for adsorption was 19% as measured using a white daylight fluorescent lamp as light source. Thus decomposition of hydrogen sulfide occurred even when a weak fluorescent lamp was used.

### Example 8

To 10 kg of the photo-catalytic slurry prepared in Example 6, 135 kg of pure water and 5 kg of calcium carbonate having an average particle diameter of 14 μm as measured by the laser diffraction-scattering particle size measuring method (“Whiton B” available from Shiraishi Calcium Kaisha Ltd.). The mixture was thoroughly stirred, and then dried by the same procedure as mentioned in Example 6 to prepare a composite particle.

A film specimen was prepared from the mother-child composite particle by the method mentioned above, and an ink color-fading test was conducted. The magenta color substantially disappeared. In contrast, when a control test was conducted in a dark place for the same time, the magenta color was not faded. Thus, the disappearance of magenta color in the film specimen according to the present invention was proved to be due to the photo-catalytic a effect. The film exhibited a gloss retention of 85%. The decomposition D₀ of hydrogen sulfide except for adsorption was 70% as measured using a black light lamp as light source.

The decomposition D₀ of hydrogen sulfide except for adsorption was 10% as measured using a white daylight fluorescent lamp as light source. Thus decomposition of hydrogen sulfide occurred even when a weak fluorescent lamp was used.

### Example 9

The photo-catalytic slurry prepared in Example 6 was dried by a working media-flowing dryer (slurry drier available from Ookawara Mfg. Co.) to prepare child particles. By the same procedures as described in Example 4, a composite particle comprised of a calcium carbonate mother particle, and, supported thereon, child particles comprising fine titanium dioxide particles having a Brφnsted acid salt supported on the surface thereof.

A film specimen was prepared from the mother-child composite particle by the method mentioned above, and an ink color-fading test was conducted. The magenta color substantially disappeared. In contrast, when a control test was conducted In a dark place for the same time, the magenta color was not faded. Thus, the disappearance of magenta color in the film specimen according to the present invention was proved to be due to the photo-catalytic effect. The film exhibited a gloss retention of 80%. The decomposition D₀ of hydrogen sulfide except for adsorption was 71% as measured using a black light lamp as light source.

The decomposition Do of hydrogen sulfide except for adsorption was 12% as measured using a white daylight fluorescent lamp as light source. Thus decomposition of hydrogen sulfide occurred even when a weak fluorescent lamp was used.

### Comparative Example 1

Super-mixer SMG-100 having a-volume of 100 liters (available from K.K. Kawata) was charged with 27 kg of calcium carbonate having an average particle diameter of 14 μm as measured by the laser diffraction-scattering particle size measuring method (“Whiton B” available from Shiraishi Calcium Kaisha Ltd.). Then 3 kg g of the titanium dioxide-silica composite fine particles prepared in Example I was added. The lid of the vessel was shut down, and the content was mixed and pulverized at 200 rpm for 30 seconds at room temperature. The energy constant k2 was 100.

After completion of the mixing and pulverization, the content was observed by scanning electron microscope. It was found that the content was a mere mixture of the calcium carbonate particles and the titanium dioxide-silica composite fine particles.

A film specimen was prepared from the mixed powder by the method mentioned above, and an ink color-fading test was conducted. The magenta color did not disappear. The film exhibited a gloss retention of smaller than 40%. This poor gloss retention Is believed to be due to the fact that the calcium carbonate mother particle and the titanium dioxide-silica composite fine particles were not formed into composite particles, and thus, the titanium dioxide-silica composite fine particles were directly contacted with a resin, and thus the weather resistance of resin was deteriorated by the photo-catalytic, function.

### Comparative Example 2

Super-mixer SMG-100 having a volume of 100 liters (available from K.K. Kawata) was charged with 27 kg of calcium carbonate having an average particle diameter of 14 μm as measured by the laser diffraction-scattering particle size measuring method (“Whiton B” available from Shiraishi Calcium Kaisha Ltd.). Then 3 kg g of the titanium dioxide-silica composite fine particles prepared in Example 1 was added. The lid of the vessel was shut down, and the content was mixed and pulverized at 1,500 rpm for 45 minutes at room temperature. The energy constant k2 was 67,500.

After completion of the mixing and pulverization, the treated particles stuck to the wall of super-mixer. This is due to the mixing and pulverization treatment was conducted to an undue extent. The agglomerated particles were difficult to disintegrate, and thus, had no practical use.

### Comparative Example 3

50 L of pure water as previously metered was heated to 98° C. with stirring. At that temperature, 3.6 kg of an aqueous titanium tetrachloride (available from Sumitomo Titanium K.K.) solution having a titanium concentration of 15% by mass was dropwise added over a period of 120 minutes. Thus-obtained white turbid slurry was subjected to electric dialysis to be thereby dechlorinated to obtain a slurry having a pH value of 4. A part of the slurry was taken and the solid content was measured by a dry constant mass method. The sold content was 2% by mass.

X-ray diffraction analysis of the dry powder revealed that the powder was predominantly comprised of brookite titanium dioxide. More specifically the dry powder contained 89% by mass of brookite titanium dioxide and 11% by mass of anatase titanium dioxide.

A part of the above-mentioned slurry was dried by a working media-flowing dryer (slurry drier available from Ookawara Mfg. Co.) to prepare child particles. By the same procedures as described in Example 4, a composite particle comprised of a calcium carbonate mother particle, and, supported thereon, child particles comprising fine titanium dioxide particles.

A film specimen was prepared from the composite particle y the method mentioned above, and an ink color-fading test was conducted. The magenta color substantially disappeared. But, the film exhibited a gloss retention of smaller than 30%. This poor gloss retention is believed to be due to the fact that the child titanium dioxide particles were not treated with a pyrophosphate and thus were not formed into a composite particle with the mother particle. Therefore, the child titanium dioxide particles were dispersed as they were in a resin, and thus, the weather resistance of resin was deteriorated by the photo-catalytic function.

### Comparative Example 4

To 10 kg of the photo-catalytic slurry prepared in Example 6, 1,000 g of calcium carbonate having an average particle diameter of 14 μm as measured by the laser diffraction-scattering particle size measuring method (“Whiton B” available from Shiraishi Calcium Kaisha Ltd.). The mixture was thoroughly stirred, and then dried by the same procedure as mentioned in Example 6 to prepare a composite particle.

A film specimen was prepared from the composite particle by the method mentioned above, and an ink color-fading test was conducted. The magenta color substantially disappeared. But, the film exhibited a very small gloss retention of 18%.

### Field of Utilization in Industry

In the case when the composite particle of the present invention is mixed with an organic polymer to prepare an organic polymer composition, and the composition is shaped, a shaped article exhibiting ultraviolet ray-screening function can be obtained. The shaped article is in the form of, for example, fiber, film or a plastic molding.

When the composite particle of the present invention is kneaded together with a resin to prepare a film, or it is coated together with a resin binder on a structure, the resulting film or structure is characterized in that the particles having a photo-catalytic activity are partially exposed on the outside. Therefore, the photo-catalytic activity of particles can be sufficiently manifested and the decomposition of the resin constituting the film or coating can be minimized. Thus, the film or structure has enhanced weather resistance. The film or structure with the composite particle having a good durability can be made at a low cost.

In the case when the smaller particles of the composite particle of the present invention are titanium dioxide fine particles containing a Brφnsted acid salt or titanium dioxide-silica composite fine particles, the photo-catalytic activity of the film or structure can be manifested to a satisfying extent even when light is weak, for example, in the room.

1. A composite particle comprised of a larger particle and, supported thereon, smaller particles wherein the smaller particles are photocatalyst-containing fine particles having an average particle diameter in the range of 0.005 μm to 0.5 μm as calculated from a BET specific surface area, and the larger particle has an average particle diameter in the range of 2 μm to 200 μm as measured by the laser diffraction-scattering particle size measuring method.

2. The composite particle according to claim 1, wherein the smaller particles comprise titanium dioxide as a photocatalyst.

3. The composite particle according to claim 1, wherein the smaller particles are composite particles comprising titanium dioxide and an inorganic compound exhibiting no photo-catalytic activity.

4. The composite particle according to claim 3, wherein the inorganic compound exhibiting no photo-catalytic activity is silica and the content of silica in the smaller particles is at least 0.5% by mass but not larger than 50% by mass, based oln the mass of the smaller particles.

5. The composite particle according to claim 1, wherein the smaller particles contain a Brφnsted acid salt.

6. The composite particle according to claim 5, wherein the smaller particles are titanium dioxide particles containing the Brφnsted acid salt on the surfaces of particles.

7. The composite particle according to claim 6, wherein the Brφnsted acid salt is a condensed phosphate.

8. The composite particle according to claim 5, wherein the smaller particles contain the Brφnsted acid salt in an amount in the range of 0.01% by mass to 50% by mass.

9. The composite particle according to claim 2, wherein the titanium dioxide comprises a brookite crystalline phase.

10. The composite particle according to claim 1, wherein the larger particle is a spherical resin particle having a melting point of at least 150° C.

11. The composite particle according to claim 1, wherein the larger particle is comprised of a hydroxide, oxide or carbonate, which contains at least one kind of element selected from the group consisting of aluminum, magnesium, calcium and silicon.

12. The composite particle according to claim 1, wherein the amount of smaller particles is in the range of 0.5% by mass to 40% by mass based on the mass of the larger particle.

13. A method of producing a composite particle as claimed in claim 1, comprising dry-mixing the smaller particles and the larger particle by a ball mill, characterized in that the dry-mixing is carried out under conditions such that k value as defined by the following equation (1) is in the range of 50 to 50,000,
k=(wm/wp)×d×n×t equation (1):
where k is energy constant for dry-mixing,
wp is total mass (g) of particles to be dry-mixed,
wm is mass (g) of mixing media,
d is inner diameter (m) of ball mill,
n is number of rotation (rpm) of ball mill, and
t is time (min) for dry-mixing.

14. A method of producing a composite particle as claimed in claim 1, comprising mixing, pulverizing and stirring the smaller particles and the larger particle by a powder-treating apparatus provided with rotary blades, characterized in that the mixing, pulverizing and stirring are carried out under conditions such that k2 value as defined by the following equation (2) is in the range of 250 to 50,000,
k2=n×t equation (2):
where n is number of rotation (rpm) of rotary blades, and
t is time (min) for mixing, pulverizing and stirring.

15. A method of producing a composite particle as claimed in claim 1, comprising mixing, pulverizing and stirring the smaller particles and the larger particle by a shaking-type powder-treating apparatus, characterized in that the mixing, pulverizing and stirring are carried out under conditions such that k3 value as defined by the following equation (3) is in the range of 50 to 50,000,
k3=n×t equation (3):
where n is number of shaking per minute, and t is time (min) for mixing, pulverizing and stirring.

16. A organic polymer composition comprising an organic polymer and a composite particle as claimed in claim 1, wherein the amount of the composite particle is in the range of 0.01% to 80% by mass based on the total mass of the organic polymer composition.

17. The organic polymer composition according to claim 16 wherein the organic polymer is at least one kind of resin selected from the group consisting of synthetic thermoplastic resins, synthetic thermosetting resins and natural resins.

18. The organic polymer composition according to claim 16, wherein the organic polymer composition is a compound.

19. The organic polymer composition according to claim 16, wherein the organic polymer composition is a master batch.

20. A shaped article made by shaping an organic polymer composition as claimed in of claim 16.

21. A coating composition comprising a composite particle as claimed in claim 1.

22. A paint composition comprising a composite particle as claimed in claim 1.

23. A structure comprising on a surface thereof a composite particle as claimed in claim 1.

24. A cosmetic composition comprising a composite particle as claimed in claim 1.

25. A fiber comprising a composite particle as claimed in claim 1.

26. A film comprising a composite particle as claimed in claim 1.
